(19) United States
(12) Patent Application Publication
(10) Pub. No.: US 2023/0087471 A1
(43) Pub. Date: Mar. 23, 2023

(54) METHOD AND APPARATUS FOR PROCESSING TRACK DATA OF MULTIMEDIA FILE, AND MEDIUM AND DEVICE

(71) Applicant: Tencent Technology (Shenzhen) Company Limited, Shenzhen (CN)

(72) Inventor: Ying HU, Shenzhen (CN)

(73) Assignee: Tencent Technology (Shenzhen) Company Limited, Shenzhen (CN)

(21) Appl. No.: 17/988,987

(22) Filed: Nov. 17, 2022

Related U.S. Application Data
(63) Continuation of application No. PCT/CN2021/136308, filed on Dec. 8, 2021.

(30) Foreign Application Priority Data
Feb. 9, 2021 (CN) 202110181956.6

(51) Int. Cl. H04N 19/70; H04N 19/136; H04N 19/44

(52) U.S. Cl. CPC H04N 19/70; H04N 19/136; H04N 19/44

(57) ABSTRACT

Embodiments of this disclosure provide a method and apparatus for processing track data in a multimedia file, a medium, and a device. The processing method includes: receiving a multimedia file, the multimedia file including a plurality of track data and track group information corresponding to the respective track data, where the track group information corresponding to target track data includes identification information of a plurality of track groups, and the identification information of the plurality of track groups is used for indicating that the target track data belongs to the plurality of track groups simultaneously; parsing the track group information to obtain a track group to which the respective track data belongs; and decoding track data belonging to a specified track group to obtain multimedia data corresponding to the specified track group.

### RELATED APPLICATION

This application is a continuation of International Patent Application No. PCT/CN2021/136308, filed on Dec. 8, 2021, which claims priority to Chinese Patent Application No. 202110181956.6, entitled “METHOD AND APPARATUS FOR PROCESSING TRACK DATA IN MULTIMEDIA FILE, MEDIUM, AND DEVICE” and filed with the China National Intellectual Property Administration on Feb. 9, 2021. The entireties of the above applications are incorporated by reference.

### TECHNICAL FIELD

This application relates to the field of computer and communication technologies, and in particular, to a method and apparatus for processing track data in a multimedia file, a medium, and a device.

### BACKGROUND

A multimedia file generally includes a plurality of tracks, such as video tracks, audio tracks and text tracks. The video tracks may also be divided into different tracks according to different types, such as a plurality of tracks divided based on different viewpoints and a plurality of tracks divided based on different types of regions. In existing standards, when a plurality of tracks have the same properties or have some kind of association with each other, these tracks may be associated by a track group, i.e. divided into a track group. However, when a certain/some tracks have a plurality of different attributes, how to indicate the attributes of such tracks is an unsolved technical problem at present.

### SUMMARY

Embodiments of this disclosure provide a method and apparatus for processing track data in a multimedia file, a medium, and a device, which may indicate track data having a plurality of attributes at least to a certain extent, meet the requirements of a multi-attribute track application scenario and improve the accuracy and completeness of track attribute indication.

Other features and advantages of this disclosure become obvious through the following detailed descriptions, or may be partially learned partially through the practice of this disclosure.

According to one aspect of the embodiments of this disclosure, a method for processing track data in a multimedia file is provided, including: receiving a multimedia file, the multimedia file comprising a plurality of track data, including target track data, and track group information corresponding to the respective track data, wherein: the track group information corresponding to the target track data comprises identification information of a plurality of track groups; and the identification information of the plurality of track groups is used for indicating that the target track data contemporaneously belong to the plurality of track groups; parsing the track group information corresponding to the respective track data to obtain a track group to which the respective track data belongs; and decoding track data belonging to a specified track group based on the track group to which the respective track data belongs to obtain multimedia data corresponding to the specified track group.

According to one aspect of the embodiments of this disclosure, a method for processing track data in a multimedia file is provided, including: generating a multimedia file, the multimedia file comprising a plurality of track data, including target track data, and track group information corresponding to the respective track data, wherein: the track group information corresponding to the target track data comprises identification information of a plurality of track groups; and the identification information of the plurality of track groups is used for indicating that the target track data belongs to the plurality of track groups simultaneously; and transmitting the multimedia file to a receiver, whereby the receiver parses the track group information corresponding to the respective track data, and decodes track data belonging to a specified track group based on the parsed track group to which the respective track data belongs.

According to one aspect of the embodiments of this disclosure, an apparatus for processing track data in a multimedia file is provided, including: a receiving unit, configured to receive a multimedia file, the multimedia file including a plurality of track data and track group information corresponding to the respective track data, the track group information corresponding to target track data including identification information of a plurality of track groups, the identification information of the plurality of track groups being used for indicating that the target track data belongs to the plurality of track groups simultaneously; a parsing unit, configured to parse the track group information corresponding to the respective track data to obtain a track group to which the respective track data belongs; and a decoding unit, configured to decode track data belonging to a specified track group based on the track group to which the respective track data belongs, so as to obtain multimedia data corresponding to the specified track group.

According to one aspect of the embodiments of this disclosure, an apparatus for processing track data in a multimedia file is provided, including: a generation unit, configured to generate a multimedia file, the multimedia file including a plurality of track data and track group information corresponding to the respective track data, the track group information corresponding to target track data including identification information of a plurality of track groups, the identification information of the plurality of track groups being used for indicating that the target track data belongs to the plurality of track groups simultaneously; and a transmission unit, configured to transmit the multimedia file to a receiver device, whereby the receiver device parses the track group information corresponding to the respective track data included in the multimedia file, and decodes track data belonging to a specified track group based on the parsed track group to which the respective track data belongs.

According to one aspect of the embodiments of this disclosure, a non-transitory computer-readable medium is provided, storing a computer program, the computer program, when executed by a processor, implementing the method for processing track data in a multimedia file according to the foregoing embodiments.

According to one aspect of the embodiments of this disclosure, an electronic device is provided, including: one or more processors; and a storage apparatus, configured to store one or more programs, the one or more programs, when executed by the one or more processors, causing the one or more processors to implement the method for processing track data in a multimedia file according to the foregoing embodiments.

According to one aspect of the embodiments of this disclosure, a computer program product or a computer program is provided, including computer instructions, the computer instructions being stored in a computer-readable storage medium. A processor of a computer device reads the computer instructions from the computer-readable storage medium, and executes the computer instructions, so that the computer device performs the method for processing track data in a multimedia file provided in the foregoing optional embodiments.

It is to be understood that the foregoing general descriptions and the following detailed descriptions are merely for illustration and explanation purposes and are not intended to limit this application.

### BRIEF DESCRIPTION OF THE DRAWINGS

Accompanying drawings herein are incorporated into and constitute a part of this specification, show embodiments that conform to this application, and are used together with this specification to describe the principle of this disclosure. Apparently, the accompanying drawings in the following description show merely some embodiments of this disclosure, and a person of ordinary skill in the art may still derive other drawings from these accompanying drawings without creative efforts. In the drawings:

FIG. 1 shows a schematic diagram of an exemplary system architecture to which a technical solution according to an embodiment of this disclosure may be applied.

FIG. 2 shows a schematic diagram of placement modes of a video coding apparatus and a video decoding apparatus in a streaming transmission system.

FIG. 3 shows a flowchart of a method for processing track data in a multimedia file according to an embodiment of this disclosure.

FIG. 4 shows a flowchart of a method for processing track data in a multimedia file according to an embodiment of this disclosure.

FIG. 5 shows a flowchart of a method for processing track data in a multimedia file according to an embodiment of this disclosure.

FIG. 6 shows a block diagram of an apparatus for processing track data in a multimedia file according to an embodiment of this disclosure.

FIG. 7 shows a block diagram of an apparatus for processing track data in a multimedia file according to an embodiment of this disclosure.

FIG. 8 shows a schematic structural diagram of a computer system adapted to implement an electronic device according to an embodiment of this disclosure.

### DESCRIPTION OF EMBODIMENTS

Exemplary implementations are now described more comprehensively with reference to the accompanying drawings. However, the examples of implementations may be implemented in multiple forms, and are not to be understood as being limited to the examples of implementations described herein. Conversely, the implementations are provided to make this application more comprehensive and complete, and comprehensively convey the idea of the examples of the implementations to a person skilled in the art.

In addition, the described features, structures, or characteristics may be combined in one or more embodiments in any appropriate manner. In the following descriptions, more specific details are provided to provide a comprehensive understanding of the embodiments of this disclosure. However, a person skilled in the art is to be aware that, the technical solutions in this application may be implemented without one or more of the specific details, or another method, unit, apparatus, or step may be used. In other cases, well-known methods, apparatuses, implementations, or operations are not shown or described in detail, to avoid obscuring aspects of this disclosure.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely examples for descriptions, do not need to include all content and operations/steps, and do not need to be performed in the described orders either. For example, some operations/steps may be further divided, while some operations/steps may be combined or partially combined. Therefore, an actual execution order may change according to an actual case.

“Plurality of” mentioned in the specification means two or more. And/or describes an association relationship for describing associated objects and represents that three relationships may exist. For example, A and/or B may represent the following three cases: only A exists, both A and B exist, and only B exists. The character “/” generally indicates an “or” relationship between the associated objects.

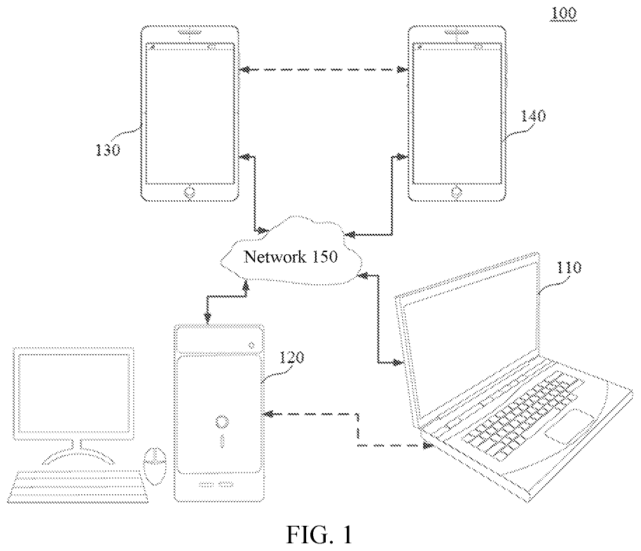

FIG. 1 shows a schematic diagram of an exemplary system architecture to which a technical solution according to an embodiment of this disclosure may be applied.

As shown in FIG. 1, a system architecture 100 includes a plurality of terminal apparatuses. The terminal apparatuses may communicate with each other via, for example, a network 150. For example, the system architecture 100 may include a first terminal apparatus 110 and a second terminal apparatus 120 interconnected via the network 150. In an embodiment of FIG. 1, the first terminal apparatus 110 and the second terminal apparatus 120 perform unidirectional data transmission.

For example, the first terminal apparatus 110 may code video data (for example, a video stream collected by the terminal apparatus 110) for transmission over the network 150 to the second terminal apparatus 120. The coded video data is transmitted in one or more coded video code streams. The second terminal apparatus 120 may receive the coded video data from the network 150, decode the coded video data to restore the video data, and display a video picture according to the restored video data.

In an embodiment of this disclosure, the system architecture 100 may include a third terminal apparatus 130 and a fourth terminal apparatus 140 that perform bi-directional transmission of the coded video data. The bi-directional transmission may occur, for example, during video communication. For bi-directional data transmission, each terminal apparatus in the third terminal apparatus 130 and the fourth terminal apparatus 140 may code video data (for example, a video picture stream collected by the terminal apparatus) for transmission over the network 150 to the other terminal apparatus in the third terminal apparatus 130 and the fourth terminal apparatus 140. Each terminal apparatus in the third terminal apparatus 130 and the fourth terminal apparatus 140 may also receive the coded video data transmitted by the other terminal apparatus in the third terminal apparatus 130 and the fourth terminal apparatus 140, may decode the coded video data to restore the video data, and may display a video picture on an accessible display apparatus according to the restored video data.

In the embodiment of FIG. 1, the first terminal apparatus 110, the second terminal apparatus 120, the third terminal apparatus 130, and the fourth terminal apparatus 140 may be a server, a personal computer and a smart phone, but the principles disclosed in this application may not be limited thereto. Embodiments disclosed in this application are applicable to laptop computers, tablet computers, media players, and/or dedicated video conferencing devices.

The network 150 represents any number of networks that communicate the coded video data between the first terminal apparatus 110, the second terminal apparatus 120, the third terminal apparatus 130, and the fourth terminal apparatus 140, including, for example, wired and/or wireless communication networks. The communication network 150 may exchange data in circuit-switched and/or packet-switched channels. The network may include a telecommunications network, a local area network, a wide area network, and/or the Internet. For purposes of this disclosure, unless explained below, the architecture and topology of the network 150 is not limited to the operation disclosed in this application.

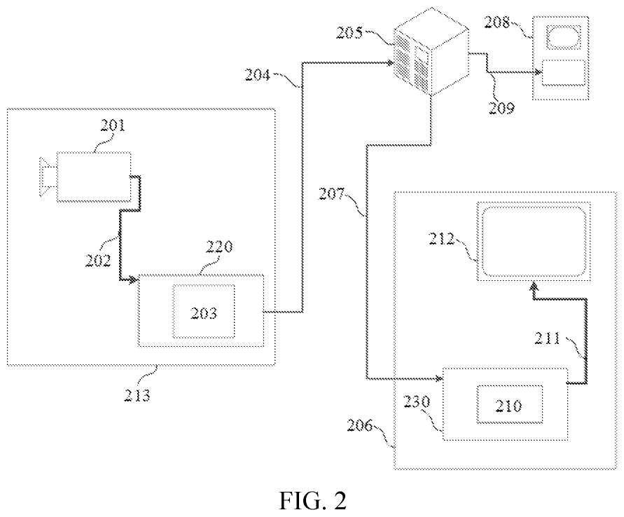

In an embodiment of this disclosure, FIG. 2 shows placement modes of a video coding apparatus and a video decoding apparatus in a streaming transmission environment. The subject matter disclosed in this application is equally applicable to other video-enabled applications including, for example, video conferencing, digital television (TV), storing compressed video on digital media including CD, DVD, memory sticks, etc.

A streaming transmission system may include an acquisition subsystem 213. The acquisition subsystem 213 may include a video source 201, such as a digital camera and a media generation device. The video source creates an uncompressed video picture stream 202. In an embodiment, the video picture stream 202 includes samples taken by a digital camera or generated samples. In contrast to coded video data 204 (or a coded video code stream 204), the video picture stream 202 is depicted as a bold line to emphasize a high-data-volume video picture stream. The video picture stream 202 may be processed by an electronic apparatus 220. The electronic apparatus 220 includes a video coding apparatus 203 coupled to the video source 201.

The video coding apparatus 203 may include hardware, software, or a combination of hardware and software to realize or implement aspects of the disclosed subject matter as described in more detail below. In contrast to the video picture stream 202, the coded video data 204 (or the coded video code stream 204) is depicted as a thin line to emphasize low-data-volume coded video data 204 (or the coded video code stream 204), which may be stored on a streaming transmission server 205 for future use.

One or more streaming transmission client subsystems, such as a client subsystem 206 and a client subsystem 208 in FIG. 2, may access the streaming transmission server 205 to retrieve a copy 207 and a copy 209 of the coded video data 204. The client subsystem 206 may include, for example, the video decoding apparatus 210, such as a video decoder, in the electronic apparatus 230. The video decoding apparatus 210 decodes the copy 207 of the coded video data and generates an output video picture stream 211 that may be presented on a display 212 (for example, a display screen) or another presentation apparatus. In some streaming transmission systems, the coded video data 204, video data 207 and video data 209 (for example, video code streams) may be coded according to certain video coding/compression standards.

The electronic apparatus 220 and the electronic apparatus 230 may include other components not shown in the figures. For example, the electronic apparatus 220 may include a video file decoding apparatus, and the electronic apparatus 230 may also include a video file coding apparatus.

In an embodiment of this disclosure, video data in the above embodiments generally includes a plurality of tracks. In existing standards, when a plurality of tracks have the same properties or have some kind of association with each other, these tracks may be associated by a track group, i.e. divided into a track group. However, the syntax of the track group in the existing standard specifies that a single track includes at most one track group data box, i.e. one track can at most only belong to one track group. This provision avoids confusion in the definition of the track group, but ignores that a track tends to have a plurality of different attributes in some scenarios.

Taking a panoramic video as an example, a plurality of viewpoints may be defined in the content of a panoramic video. A viewpoint is a spherical video, and a plane frame corresponding to the spherical video may be spatially divided into a plurality of different independently coded and decoded regions. Then, the independently coded and decoded regions of one spherical video belong to both a part of a single viewpoint (i.e. spherical video) and a part of the content of the entire panoramic video. Based on existing standards, the track group only allows to organize different tracks according to one of the relationships (i.e. attributes), which obviously results in inaccuracies in association relationships between tracks.

Therefore, an embodiment of this disclosure introduces a multi-dimensional association relationship indication scheme to indicate certain track information having a plurality of attributes on the basis of the definition of an existing track group. The detailed description is as follows:

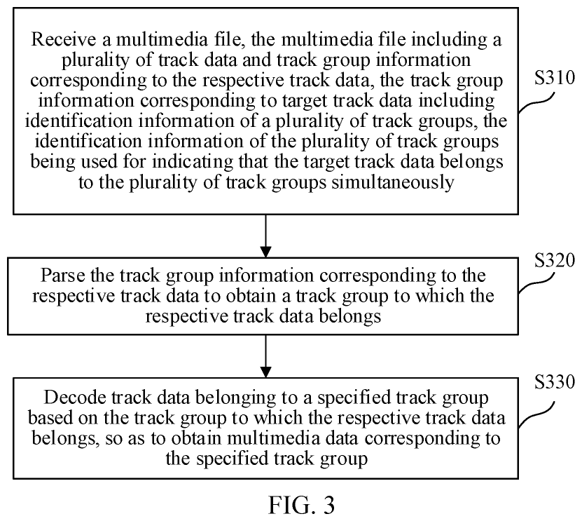

FIG. 3 shows a flowchart of a method for processing track data in a multimedia file according to an embodiment of this disclosure. The method for processing track data in a multimedia file may be performed by an electronic device, for example, a playing device of a multimedia file. The playing device may be a smart phone, a tablet computer, a notebook computer, a desktop computer, etc. Referring to FIG. 3, the method for processing track data in a multimedia file includes at least steps S310 to S330, which are described in detail as follows:

In step S310, a multimedia file is received. The multimedia file includes a plurality of track data and track group information corresponding to the respective track data. The track group information corresponding to target track data includes identification information of a plurality of track groups. The identification information of the plurality of track groups is used for indicating that the target track data belongs to the plurality of track groups simultaneously.

In an embodiment of this disclosure, the target track data may be part of track data in the plurality of track data included in the multimedia file, or may be all the track data. For example, when four track data are included in the multimedia file, one, two or three of the four track data may be the aforementioned target track data, or all of the four track data may be the aforementioned target track data.

In the plurality of track data included in the multimedia file, it is also possible that track group information corresponding to the part of track data includes identification information of one track group. That is, it is possible that the partial track data in the plurality of track data only belongs to one track group.

In an embodiment of this disclosure, the multimedia file may be a video file, an audio file, an image file, etc. Exemplarily, the multimedia file may be an immersive media file, i.e. a media file that makes a viewing object feel immersive through an audio-video technology.

In an embodiment of this disclosure, the track group information corresponding to the target track data may include identification information of a first track group and identification information of a second track group. That is, the plurality of track groups in the aforementioned embodiments may include the first track group and the second track group. The track group information corresponding to the target track data may include a track group type data box corresponding to the first track group. The track group type data box includes identification information of the first track group and information of the second track group.

In an embodiment of this disclosure, the track group type data box corresponding to the first track group may further include: content information of the target track data under a type represented by the first track group; alternatively, the track group type data box corresponding to the first track group may further include an information data box of the target track data corresponding to the first track group. The information data box may include content information of the target track data under a type represented by the first track group.

In an embodiment of this disclosure, the information of the second track group includes: identification information of the second track group, a type of the second track group, and description information of the second track group. In addition, the information of the second track group may further include: content information of the target track data under a type represented by the second track group; alternatively, the information of the second track group may further include an information data box of the target track data corresponding to the second track group. The information data box may include content information of the target track data under a type represented by the second track group.

Specifically, in an embodiment of this disclosure, for example, the first track group may be a track group corresponding to a viewpoint, and the second track group may be a track group corresponding to an independently coded and decoded region. In this case, the track group type data box corresponding to the first track group may be represented as ViewpointGroupBox( ) and the track group type data box corresponding to the first track group may include identification information of the first track group and information of the second track group. The identification information of the first track group may be, for example, track_group_id=01. The information of the second track group may include, for example, identification information of the second track group (for example, sub_group_id=0001), a type of the second track group (for example, sub_group_type=1), description information of the second track group (for example, sub_group_description), and an information data box of the target track data corresponding to the second track group, for example, IndependentlyCodedRegionBox( ) and CompositionInfoBox( ) defined in the existing standards. CompositionInfoBox( ) is used for indicating composition information, and IndependentlyCodedRegionBox( ) is used for indicating information of an independently coded region.

In addition, the track group type data box corresponding to the first track group may also include content information of the target track data under a type represented by the first track group, for example, ViewpointInfoStruct( ) string viewpoint_label, viewpoint_id=01, and viewpoint_type defined in the existing standards. ViewpointInfoStruct( ) is used for indicating position information of a viewpoint, string viewpoint_label is used for indicating a label of a viewpoint; viewpoint_id=01 is used for indicating an identifier of a viewpoint; viewpoint_type is used for indicating a type of a viewpoint.

For examples in the above embodiments, in an embodiment of this disclosure, the first track group may also be a track group corresponding to an independently coded and decoded region, and the second track group may also be a track group corresponding to a viewpoint. In this case, the track group type data box corresponding to the first track group may be represented as IndependentlyCodedRegionDescriptionBox( ) and the track group type data box corresponding to the first track group may include identification information of the first track group and information of the second track group. The identification information of the first track group may be, for example, track_group_id=01. The information of the second track group may include, for example, identification information of the second track group (for example, hyper_group_id=0001), a type of the second track group (for example, hyper_group_type=1), description information of the second track group (for example, hyper_group_description), and content information of the target track data under a type represented by the second track group, for example, ViewpointInfoStruct( ) string viewpoint_label, viewpoint_id=01, and viewpoint_type defined in the existing standards. ViewpointInfoStruct( ) is used for indicating position information of a viewpoint, string viewpoint_label is used for indicating a label of a viewpoint, viewpoint_id=01 is used for indicating an identifier of a viewpoint, and viewpoint_type is used for indicating a type of a viewpoint.

In addition, the track group type data box corresponding to the first track group may further include an information data box of the target track data corresponding to the first track group, for example, IndependentlyCodedRegionBox( ) and CompositionInfoBox( ) defined in the existing standards. CompositionInfoBox( ) is used for indicating composition information, and IndependentlyCodedRegionBox( ) is used for indicating information of an independently coded region.

In an embodiment of this disclosure, the aforementioned first track group may have a hierarchical relationship with the second track group. Specifically, the hierarchy of the first track group may be higher than that of the second track group, or the hierarchy of the first track group may also be lower than that of the second track group.

In an embodiment of this disclosure, when the plurality of track groups further including a third track group other than the first track group and the second track group, the track group type data box further includes information of the third track group. Exemplarily, the information of the third track group and the information of the second track group may be included in the track group type data box in parallel. That is, in the track group type data box corresponding to the first track group, the information of the third track group and the information of the second track group are in parallel. Alternatively, the information of the third track group may be nested in the information of the second track group.

The information of the third track group is similar to the information of the aforementioned second track group; for example, the information of the third track group may include identification information of the third track group, a type of the third track group, and description information of the third track group. In addition, the information of the third track group may further include: content information of the target track data under a type represented by the third track group; alternatively, the information of the third track group may further include an information data box of the target track data corresponding to the third track group, the information data box including content information of the target track data under a type represented by the third track group.

The plurality of track groups in the aforementioned embodiments may include more track groups than the first track group, the second track group and the third track group. In this case, the information of the track groups may be nested with each other like the third track group.

With continued reference to FIG. 3, in step S320, the track group information corresponding to the respective track data is parsed to obtain a track group to which the respective track data belongs.

In an embodiment of this disclosure, after the track group information corresponding to the target track data in the multimedia file is parsed, a plurality of track groups to which the target track data belongs may be obtained. Certainly, there may also be some track data in the multimedia file belonging to only one track group.

In step S330, track data belonging to a specified track group is decoded based on the track group to which the respective track data belongs, so as to obtain multimedia data corresponding to the specified track group.

In an embodiment of this disclosure, for example, when a certain track group needs to be concerned, track data belonging to the track group may be decoded. Specifically, for example, the multimedia file may be an immersive media file, and the plurality of track groups include a track group for indicating a viewpoint type and a track group for indicating an independently coded and decoded region. In this case, according to a target viewpoint and a target region viewed by a viewing object of the immersive media file, track data in a track group corresponding to the target viewpoint and the target region may be decoded.

In an embodiment of this disclosure, after obtaining multimedia data corresponding to the specified track group by decoding, the multimedia data obtained may be presented.

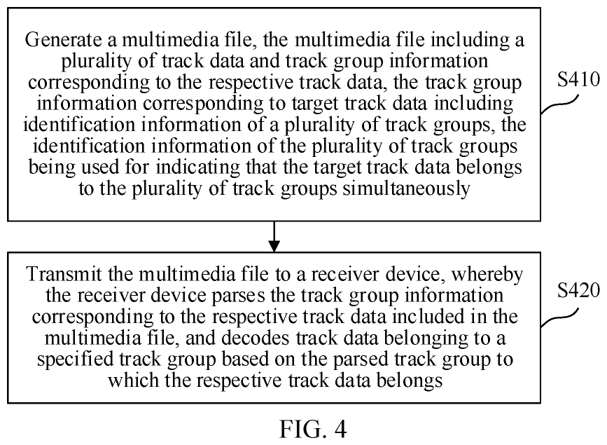

FIG. 4 shows a flowchart of a method for processing track data in a multimedia file according to an embodiment of this disclosure. The method for processing track data in a multimedia file may be performed by an electronic device, for example, a generation device of a multimedia file. The generation device may be a server, an unmanned aerial vehicle, a phone terminal, etc. Referring to FIG. 4, the method for processing track data in a multimedia file includes at least steps S410 to S420, which are described in detail as follows:

In step S410, a multimedia file is generated. The multimedia file includes a plurality of track data and track group information corresponding to the respective track data. The track group information corresponding to target track data includes identification information of a plurality of track groups. The identification information of the plurality of track groups is used for indicating that the target track data belongs to the plurality of track groups simultaneously.

In step S420, the multimedia file is transmitted to a receiver device, whereby the receiver device parses the track group information corresponding to the respective track data included in the multimedia file, and decodes track data belonging to a specified track group based on the parsed track group to which the respective track data belongs.

The relevant content description of an embodiment shown in FIG. 4 is similar to the content of the aforementioned embodiments and will not be repeated.

The implementation details of the technical solution of the embodiments of this disclosure are described below in detail with an example where a multimedia file is an immersive media file.

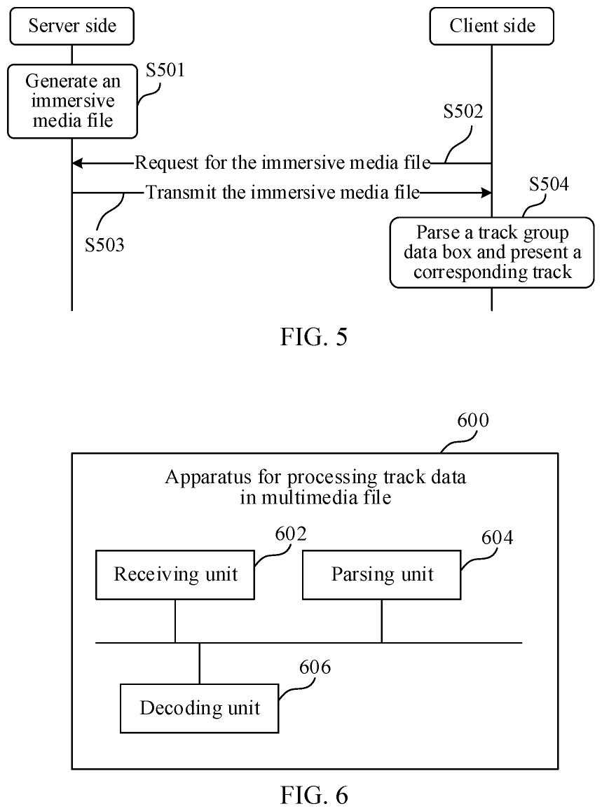

As shown in FIG. 5, the description is made with an example where a server side generates an immersive media file and a client side consumes the immersive media file. The following steps may be specifically included:

Step S501. A server side generates an immersive media file.

In an embodiment of this disclosure, the server side may be a device having an immersive media coding capability, such as a server, an unmanned aerial vehicle and a phone terminal. The server side may indicate association relationship information of different dimensions in a track group data box according to an association relationship of media contents, and generate track group information corresponding to respective track data.

Step S502. A client side requests the server side for the immersive media file.

Step S503. The server side transmits the immersive media file to the client side.

Step S504. The client side parses a track group data box included in the immersive media file to obtain an association relationship of different hierarchies of track groups, and correspondingly decodes and presents different tracks according to the association relationship and user requirements.

In order to implement the technical solution of an embodiment shown in FIG. 5, in an embodiment of this disclosure, some descriptive field information, including field extensions at a file encapsulation level, is added. The following is an example in the form of an extended ISOBMFF data box that defines relevant information for immersive media. Respective extended fields are as follows:

SubGroupInfoBox(0,0): used for indicating information of a track sub-group, which is an optional field;

HyperGroupInfoBox(0,0): used for indicating information of a track hyper-group, which is an optional field.

SubGroupInfoBox(0,0) includes the following fields:

sub_group_type: used for indicating a type of a track sub-group, a value of this field being related to a type of a track group;

sub_group_id: used for indicating an identifier of a track sub-group;

sub_group_description: used for indicating description information of a track sub-group, which is a character string ending with a null character.

In addition to the above fields, other data boxes may be added according to the attributes of the track sub-group.

HyperGroupInfoBox(0,0) includes the following fields:

hyper_group_type: used for indicating a type of a track hyper-group, a value of this field being related to a type of a track group;

hyper_group_id: used for indicating an identifier of a track hyper-group;

hyper_group_description: used for indicating description information of a track hyper-group, which is a character string ending with a null character.

In addition to the above fields, other data boxes may be added according to the attributes of the track hyper-group.

In an embodiment of this disclosure, when track groups are associated multi-dimensionally, the association may be performed in a way that track groups of the largest dimension are associated on a basis, and then grouping information of a smaller dimension is indicated in the track group type data box in a sub-group information data box. Certainly, the association may also be performed in a way that track groups of the smallest dimension are associated on a basis, and then grouping information of a larger dimension is indicated in the track group type data box in a hyper-group information data box. In addition, if a track has attributes corresponding to three or more dimensions, the sub-group information data box may also be nested with another sub-group information data box. Similarly, the hyper-group information data box may also be nested with another hyper-group information data box.

In conjunction with the technical solution of the above embodiments, the content of a track group type data box is described in detail with an example of an immersive media file:

in an embodiment of this disclosure, it is assumed that there is an immersive media file F0 in an immersive media server side node, which includes two viewpoints: VPI1 and VPI2. Each viewpoint is divided into two independently coded and decoded regions A and B, thus forming four tracks track1-track4. When associating with a track hyper-group as a basic association manner, track group information included in the four tracks is as follows:

```
  Track1: Independently coded and decoded region A in VP1
  ViewpointGroupBox(extends TrackGroupTypeBox):
  {
  track_group_id=01; //indicating an identifier of a track group (track
  hyper-group)
  ViewpointInfoStruct( ); //indicating position information of a viewpoint,
  etc.
  string viewpoint_label; //indicating a label of a viewpoint
  viewpoint_id=01; //indicating an identifier of a viewpoint
  viewpoint_type; //indicating a type of a viewpoint
  sub_group_type=1; //when a track group type is a viewpoint group, a
sub-group type being 1 means that a track sub-group is an independently
coded and decoded region group
  sub_group_id = 0001; //indicating an identifier of a track sub-group
  sub_group_description; //indicating description information of a track
  sub-group
  CompositionInfoBox( ); //when a track sub-group type is an
independently coded and decoded region group, the data box needs to be
included to indicate composition information
  IndependentlyCodedRegionBox( ); //when a track sub-group type is an
independently coded and decoded region group, the data box needs to be
included to indicate information of an independently coded and decoded
region
  }
```

```
  Track2: Independently coded and decoded region B in VP1
  ViewpointGroupBox(extends TrackGroupTypeBox):
  {
  track_group_id=01; //indicating an identifier of a track group (track
  hyper-group)
  ViewpointInfoStruct( ); //indicating position information of a viewpoint,
  etc.
  string viewpoint_label; //indicating a label of a viewpoint
  viewpoint_id=01; //indicating an identifier of a viewpoint
  viewpoint_type; //indicating a type of a viewpoint
  sub_group_type=1; //when a track group type is a viewpoint group, a
sub-group type being 1 means that a track sub-group is an independently
coded and decoded region group
  sub_group_id = 0001; //indicating an identifier of a track sub-group
  sub_group_description; //indicating description information of a track
  sub-group
  CompositionInfoBox( ); //when a track sub-group type is an
independently coded and decoded region group, the data box needs to be
included to indicate composition information
  IndependentlyCodedRegionBox( ); //when a track sub-group type is an
independently coded and decoded region group, the data box needs to be
included to indicate information of an independently coded and decoded
region
  }
```

```
  Track3: Independently coded and decoded region A in VP2
  ViewpointGroupBox(extends TrackGroupTypeBox):
  {
  track_group_id=02; //indicating an identifier of a track group (track
  hyper-group)
  ViewpointInfoStruct( ); //indicating position information of a viewpoint,
  etc.
  string viewpoint_label; //indicating a label of a viewpoint
  viewpoint_id=01; //indicating an identifier of a viewpoint
  viewpoint_type; //indicating a type of a viewpoint
  sub_group_type=1; //when a track group type is a viewpoint group, a
sub-group type being 1 means that a track sub-group is an independently
coded and decoded region group
  sub_group_id = 0002; //indicating an identifier of a track sub-group
  sub_group_description; //indicating description information of a track
  sub-group
  CompositionInfoBox( ); //when a track sub-group type is an
independently coded and decoded region group, the data box needs to be
included to indicate composition information
  IndependentlyCodedRegionBox( ); //when a track sub-group type is an
independently coded and decoded region group, the data box needs to be
included to indicate information of an independently coded and decoded
region
  }
```

```
  Track4: Independently coded and decoded region B in VP2
  ViewpointGroupBox(extends TrackGroupTypeBox):
  {
  track_group_id=02; //indicating an identifier of a track group (track
  hyper-group)
  ViewpointInfoStruct( ); //indicating position information of a viewpoint,
  etc.
  string viewpoint_label; //indicating a label of a viewpoint
  viewpoint_id=01; //indicating an identifier of a viewpoint
  viewpoint_type; //indicating a type of a viewpoint
  sub_group_type=1; //when a track group type is a viewpoint group, a
sub-group type being 1 means that a track sub-group is an independently
coded and decoded region group
  sub_group_id = 0002; //indicating an identifier of a track sub-group
  sub_group_description; //indicating description information of a track
  sub-group
  CompositionInfoBox( ); //when a track sub-group type is an
independently coded and decoded region group, the data box needs to be
included to indicate composition information
  IndependentlyCodedRegionBox( ); //when a track sub-group type is an
independently coded and decoded region group, the data box needs to be
included to indicate information of an independently coded and decoded
region
  }
```

In an embodiment of this disclosure, after the client side acquires an immersive media file from an immersive media server side node, a media file F0 is parsed. Then, through information in the track group data box, it is known that track1 and track2 correspond to VP1 and track3 and track4 correspond to VP2. Then, a corresponding track may be preferentially decoded and presented according to a viewpoint and a viewing region viewed by a user.

In an embodiment of this disclosure, it is assumed that there is an immersive media file F0 in an immersive media server side node, which includes two viewpoints: VPI1 and VPI2. Each viewpoint is divided into two independently coded and decoded regions A and B, thus forming four tracks track1-track4. When associating with a track sub-group as a basic association manner, track group information included in the four tracks is as follows:

```
  Track1: Independently coded and decoded region A in VP1
  IndependentlyCodedRegionDescriptionBox (extends
  TrackGroupTypeBox):
  {
  track_group_id=01; //indicating an identifier of a track group (track
  sub-group)
  CompositionInfoBox( ); //indicating composition information
  IndependentlyCodedRegionBox( ); indicating information of an
independently coded and decoded region
  hyper_group_type=1; //when a track group type is an independently
coded and decoded region group, a hyper-group type being 1 means that a
track hyper-group is a viewpoint group
  hyper_group_id=0001; //indicating an identifier of a track hyper-group
  hyper_group_description; //indicating description information of a
track hyper-group
  ViewpointInfoStruct( ); //when a track hyper-group is a videopoint
group, this field is used for indicating position information of a viewpoint,
etc.
  string viewpoint_label; //when a track hyper-group is a videopoint
group, this field is used for indicating a label of a viewpoint
  viewpoint_id=01; //when a track hyper-group is a videopoint group,
this field is used for indicating an identifier of a viewpoint
  viewpoint_type; //when a track hyper-group is a videopoint group, this
field is used for indicating a type of a viewpoint
  }
```

```
  Track2: Independently coded and decoded region B in VP1
  IndependentlyCodedRegionDescriptionBox (extends
  TrackGroupTypeBox):
  {
  track_group_id=01; //indicating an identifier of a track group (track
  sub-group)
  CompositionInfoBox( ); //indicating composition information
  IndependentlyCodedRegionBox( ); indicating information of an
independently coded and decoded region
  hyper_group_type=1; //when a track group type is an independently
coded and decoded region group, a hyper-group type being 1 means that a
track hyper-group is a viewpoint group
  hyper_group_id=0001; //indicating an identifier of a track hyper-group
  hyper_group_description; //indicating description information of a
track hyper-group
  ViewpointInfoStruct( ); //when a track hyper-group is a videopoint
group, this field is used for indicating position information of a viewpoint,
etc.
  string viewpoint_label; //when a track hyper-group is a videopoint
group, this field is used for indicating a label of a viewpoint
  viewpoint_id=01; //when a track hyper-group is a videopoint group,
this field is used for indicating an identifier of a viewpoint
  viewpoint_type; //when a track hyper-group is a videopoint group, this
field is used for indicating a type of a viewpoint
  }
```

```
  Track3: Independently coded and decoded region A in VP2
  {
  track_group_id=02; //indicating an identifier of a track group (track
  sub-group)
  CompositionInfoBox( ); //indicating composition information
  IndependentlyCodedRegionBox( ); indicating information of an
independently coded and decoded region
  hyper_group_type=1; //when a track group type is an independently
coded and decoded region group, a hyper-group type being 1 means that a
track hyper-group is a viewpoint group
  hyper_group_id=0002; //indicating an identifier of a track hyper-group
  hyper_group_description; //indicating description information of a
track hyper-group
  ViewpointInfoStruct( ); //when a track hyper-group is a videopoint
group, this field is used for indicating position information of a viewpoint,
etc.
  string viewpoint_label; //when a track hyper-group is a videopoint
group, this field is used for indicating a label of a viewpoint
  viewpoint_id=01; //when a track hyper-group is a videopoint group,
this field is used for indicating an identifier of a viewpoint
  viewpoint_type; //when a track hyper-group is a videopoint group, this
field is used for indicating a type of a viewpoint
  }
```

```
  Track4: Independently coded and decoded region B in VP2
  {
  track_group_id=02; //indicating an identifier of a track group (track
  sub-group)
  CompositionInfoBox( ); //indicating composition information
  IndependentlyCodedRegionBox( ); indicating information of an
independently coded and decoded region
  hyper_group_type=1; //when a track group type is an independently
coded and decoded region group, a hyper-group type being 1 means that a
track hyper-group is a viewpoint group
  hyper_group_id=0002; //indicating an identifier of a track hyper-group
  hyper_group_description; //indicating description information of a
track hyper-group
  ViewpointInfoStruct( ); //when a track hyper-group is a videopoint
group, this field is used for indicating position information of a viewpoint,
etc.
  string viewpoint_label; //when a track hyper-group is a videopoint
group, this field is used for indicating a label of a viewpoint
  viewpoint_id=01; //when a track hyper-group is a videopoint group,
this field is used for indicating an identifier of a viewpoint
  viewpoint_type; //when a track hyper-group is a videopoint group, this
field is used for indicating a type of a viewpoint
  }
```

In an embodiment of this disclosure, after the client side acquires an immersive media file from an immersive media server side node, a media file F0 is parsed. Then, through information in the track group data box, it is known that track1 and track2 correspond to VP1 and track3 and track4 correspond to VP2. Then, a corresponding track may be preferentially decoded and presented according to a viewpoint and a viewing region viewed by a user.

The technical solution of the above embodiments of this disclosure may introduce a multi-dimensional association relationship indication method on the basis of the definition of an existing track group. When a certain track has a plurality of attributes, an association indication may be performed by the technical solution of the embodiments of this disclosure, and if the plurality of attributes have a hierarchical relationship, association information of respective hierarchies may also be retained. It can be seen that the technical solution of the embodiments of this disclosure satisfies the requirements of a multi-attribute track application scenario, improves the accuracy and completeness of track attribute indication, and solves the problem of only allowing one track to belong to one track group in the existing standards.

The following describes apparatus embodiments of this disclosure, which can be used for performing the method for processing track data in a multimedia file in the foregoing embodiments of this disclosure. For details not disclosed in the apparatus embodiments of this disclosure, reference may be made to the foregoing embodiments of the method for processing track data in a multimedia file of this disclosure.

FIG. 6 shows a block diagram of an apparatus for processing track data in a multimedia file according to an embodiment of this disclosure. The apparatus for processing track data in a multimedia file may be arranged in an electronic device, for example, in a playing device of a multimedia file. The playing device may be a smart phone, a tablet computer, a notebook computer, a desktop computer, etc.

As shown in FIG. 6, an apparatus 600 for processing track data in a multimedia file according to an embodiment of this disclosure includes: a receiving unit 602, a parsing unit 604 and a decoding unit 606.

The receiving unit 602 is configured to receive a multimedia file. The multimedia file includes a plurality of track data and track group information corresponding to the respective track data. The track group information corresponding to target track data includes identification information of a plurality of track groups. The identification information of the plurality of track groups is used for indicating that the target track data belongs to the plurality of track groups simultaneously. The parsing unit 604 is configured to parse the track group information corresponding to the respective track data to obtain a track group to which the respective track data belongs. The decoding unit 606 is configured to decode track data belonging to a specified track group based on the track group to which the respective track data belongs, so as to obtain multimedia data corresponding to the specified track group.

In some embodiments of this disclosure, based on the aforementioned scheme, the plurality of track groups include a first track group and a second track group, and the track group information corresponding to the target track data includes a track group type data box corresponding to the first track group. The track group type data box includes identification information of the first track group and information of the second track group.

In some embodiments of this disclosure, based on the aforementioned scheme, the track group type data box further includes: content information of the target track data under a type represented by the first track group; or an information data box of the target track data corresponding to the first track group.

In some embodiments of this disclosure, based on the aforementioned scheme, the information of the second track group includes: identification information of the second track group, a type of the second track group, and description information of the second track group.

In some embodiments of this disclosure, based on the aforementioned scheme, the information of the second track group further includes: content information of the target track data under a type represented by the second track group; or an information data box of the target track data corresponding to the second track group.

In some embodiments of this disclosure, based on the aforementioned scheme, the first track group has a hierarchical relationship with the second track group. The hierarchy of the first track group is higher than that of the second track group, or the hierarchy of the first track group is lower than that of the second track group.

In some embodiments of this disclosure, based on the aforementioned scheme, in response to the plurality of track groups further including a third track group other than the first track group and the second track group, the track group type data box further includes information of the third track group.

In some embodiments of this disclosure, based on the aforementioned scheme, the information of the third track group and the information of the second track group are included in the track group type data box in parallel. Or, the information of the third track group is nested in the information of the second track group.

In some embodiments of this disclosure, based on the aforementioned scheme, the processing apparatus 600 further includes: a presentation unit, configured to present, after obtaining multimedia data corresponding to the specified track group, the multimedia data.

In some embodiments of this disclosure, based on the aforementioned scheme, the multimedia file includes an immersive media file, and the plurality of track groups include a track group for indicating a viewpoint type and a track group for indicating an independently coded and decoded region.

In some embodiments of this disclosure, based on the aforementioned scheme, the decoding unit 606 is configured to: decode, according to a target viewpoint and a target region viewed by a viewing object of the immersive media file, track data in a track group corresponding to the target viewpoint and the target region based on the track group to which the respective track data belongs.

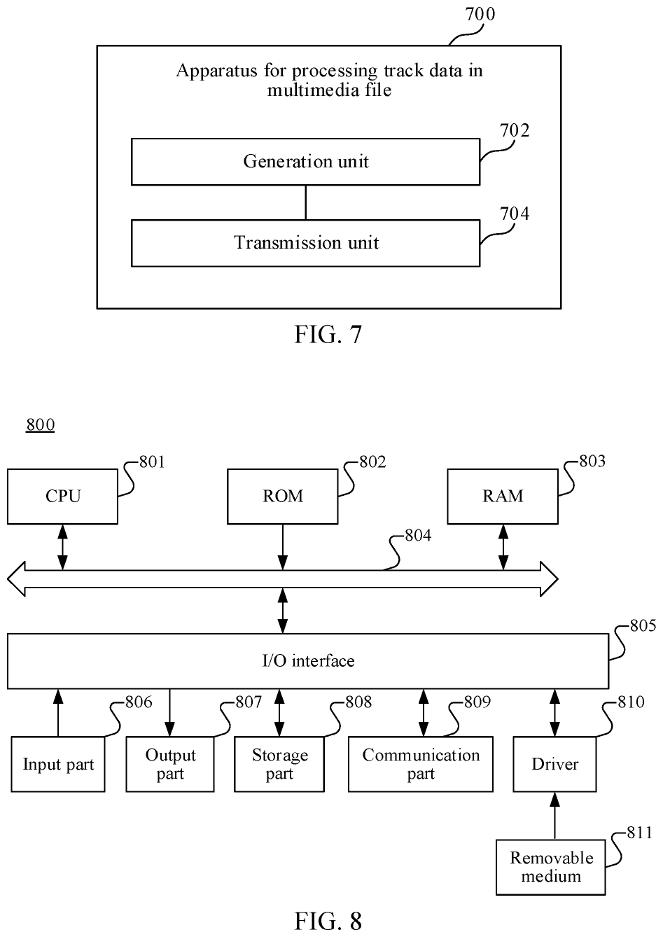

FIG. 7 shows a block diagram of an apparatus for processing track data in a multimedia file according to an embodiment of this disclosure. The apparatus for processing track data in a multimedia file may be arranged in an electronic device, for example, in a generation device of a multimedia file. The generation device may be a server, an unmanned aerial vehicle, a phone terminal, etc.

As shown in FIG. 7, an apparatus 700 for processing track data in a multimedia file according to an embodiment of this disclosure includes: a generation unit 702 and a transmission unit 704.

The generation unit 702 is configured to generate a multimedia file. The multimedia file includes a plurality of track data and track group information corresponding to the respective track data. The track group information corresponding to target track data includes identification information of a plurality of track groups. The identification information of the plurality of track groups is used for indicating that the target track data belongs to the plurality of track groups simultaneously. The transmission unit 704 is configured to transmit the multimedia file to a receiver device, whereby the receiver device parses the track group information corresponding to the respective track data included in the multimedia file, and decodes track data belonging to a specified track group based on the parsed track group to which the respective track data belongs.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

FIG. 8 shows a schematic structural diagram of a computer system adapted to implement an electronic device according to an embodiment of this disclosure.

The computer system 800 of the electronic device shown in FIG. 8 is merely an example, and does not constitute any limitation on functions and use ranges of the embodiments of this disclosure.

As shown in FIG. 8, the computer system 800 includes a central processing unit (CPU) 801, which can execute various appropriate actions and processing according to a program stored in a read-only memory (ROM) 802 or a program loaded from a storage part 808 to a random access memory (RAM) 803, such as performing the methods described in the foregoing embodiments. The RAM 803 further stores various programs and data required for operating the system. The CPU 801, the ROM 802, and the RAM 803 are connected to each other through a bus 804. An input/output (I/O) interface 805 is also connected to the bus 804.

The following components are connected to the I/O interface 805: an input part 806 including a keyboard and a mouse, etc.; an output part 807 including a cathode ray tube (CRT), a liquid crystal display (LCD), a speaker, or the like; a storage part 808 including hard disk, or the like; and a communication part 809 including a network interface card such as a local area network (LAN) card, a modem, or the like. The communication part 809 performs communication processing by using a network such as the Internet. A drive 810 is also connected to the I/O interface 805 as required. A removable medium 811, such as a disk, an optical disc, a magneto-optical disc, or a semiconductor memory, is installed on the drive 810 as required, so that a computer program read from the removable medium 1311 is installed in the storage part 808 as required.

Particularly, according to an embodiment of this disclosure, the processes described above by referring to the flowcharts may be implemented as computer software programs. For example, an embodiment of this disclosure includes a computer program product. The computer program product includes a computer program stored in a computer-readable medium. The computer program includes a computer program used for performing a method shown in the flowchart. In such an embodiment, the computer program may be downloaded and installed through the communication part 809 from a network, and/or installed from the removable medium 811. When the computer program is executed by the CPU 801, the various functions defined in the system of this disclosure are executed.

The computer-readable medium shown in the embodiments of this disclosure may be a computer-readable signal medium or a computer-readable storage medium or any combination of two. The computer-readable storage medium may be, for example, but is not limited to, an electrical, magnetic, optical, electromagnetic, infrared, or semiconductor system, apparatus, or device, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this application, the computer-readable storage medium may be any tangible medium including or storing a program, and the program may be used by or used in combination with an instruction execution system, an apparatus, or a device. In this application, a computer-readable signal medium may include a data signal in a baseband or propagated as a part of a carrier wave, the data signal carrying a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The computer program included in the computer-readable storage medium may be transmitted using any suitable medium, including but not limited to: a wireless medium, a wired medium, or the like, or any suitable combination thereof.

The flowcharts and block diagrams in the accompanying drawings illustrate possible system architectures, functions, and operations that may be implemented by a system, a method, and a computer program product according to various embodiments of this disclosure. Each box in a flowchart or a block diagram may represent a module, a program segment, or a part of code. The module, the program segment, or the part of code includes one or more executable instructions used for implementing designated logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

A related unit described in the embodiments of this disclosure may be implemented in a software manner, or may be implemented in a hardware manner, and the unit described may also be set in a processor. Names of the units do not constitute a limitation on the units in a specific case.

In another aspect, this application further provides a computer readable medium. The computer readable medium may be included in the electronic device described in the above embodiments, or may exist alone without being assembled into the electronic device. The computer-readable medium carries one or more programs, the one or more programs, when executed by the electronic device, causing the electronic device to implement the method described in the foregoing embodiments.

Although a plurality of modules or units of a device configured to perform actions are discussed in the foregoing detailed description, such division is not mandatory. Actually, according to the implementations of this disclosure, the features and functions of two or more modules or units described above may be specified in one module or unit. Conversely, features and functions of one module or unit described above may be further divided into a plurality of modules or units for implementation.

Through the descriptions of the foregoing implementations, a person skilled in the art easily understands that the exemplary implementations described herein may be implemented through software, or may be implemented through software located in combination with necessary hardware. Therefore, the technical solutions of the embodiments of this disclosure may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the embodiments of this disclosure.

After considering the specification and practicing the disclosed embodiments, a person skilled in the art may easily conceive of other implementations of this disclosure. This application is intended to cover any variations, uses or adaptive changes of this disclosure. Such variations, uses or adaptive changes follow the general principles of this disclosure, and include well-known knowledge and conventional technical means in the art that are not disclosed in this application.

It is to be understood that this application is not limited to the precise structures described above and shown in the accompanying drawings, and various modifications and changes can be made without departing from the scope of this disclosure. The scope of this disclosure is limited by the appended claims only.

What is claimed is:

1. A method for processing a multimedia file, performed by an electronic device, the method comprising:
receiving the multimedia file, the multimedia file comprising a plurality of track data, including target track data, and track group information corresponding to respective track data, wherein:
the track group information corresponding to the target track data comprises identification information of a plurality of track groups; and
the identification information of the plurality of track groups is used for indicating that the target track data contemporaneously belong to the plurality of track groups;
parsing the track group information corresponding to the respective track data to obtain a track group to which the respective track data belongs; and
decoding track data belonging to a specified track group based on the track group to which the respective track data belongs to obtain multimedia data corresponding to the specified track group.

2. The method according to claim 1, wherein the plurality of track groups comprise a first track group and a second track group, and the track group information corresponding to the target track data comprises a track group type data box corresponding to the first track group,
the track group type data box comprising identification information of the first track group and information of the second track group.

3. The method according to claim 2, wherein the track group type data box further comprises:
content information of the target track data under a type represented by the first track group; or
an information data box of the target track data corresponding to the first track group.

4. The method according to claim 2, wherein the information of the second track group comprises:
identification information of the second track group, a type of the second track group, and description information of the second track group.

5. The method according to claim 4, wherein the information of the second track group further comprises:
content information of the target track data under a type represented by the second track group; or
an information data box of the target track data corresponding to the second track group.

6. The method according to claim 2, wherein the first track group has a hierarchical relationship with the second track group, wherein:
a hierarchy of the first track group is higher than that of the second track group, or
a hierarchy of the first track group is lower than that of the second track group.

7. The method according to claim 2, wherein if the plurality of track groups further comprising a third track group other than the first track group and the second track group, the track group type data box further comprises information of the third track group.

8. The method according to claim 7, wherein:
the information of the third track group and the information of the second track group are comprised in the track group type data box in parallel; or
the information of the third track group is nested in the information of the second track group.

9. The method according to claim 1, further comprising:
presenting, after obtaining multimedia data corresponding to the specified track group, the multimedia data.

10. The method according to claim 1, wherein the multimedia file comprises an immersive media file, and the plurality of track groups comprise a track group for indicating a viewpoint type and a track group for indicating an independently coded and decoded region.

11. The method according to claim 10, wherein decoding track data belonging to the specified track group comprises:
decoding, according to a target viewpoint and a target region viewed by a viewing object of the immersive media file, track data in a track group corresponding to the target viewpoint and the target region based on the track group to which the respective track data belongs.

12. A method for processing track data in a multimedia file, performed by an electronic device, the method comprising:
generating a multimedia file, the multimedia file comprising a plurality of track data, including target track data, and track group information corresponding to the respective track data, wherein:
the track group information corresponding to the target track data comprises identification information of a plurality of track groups; and
the identification information of the plurality of track groups is used for indicating that the target track data belongs to the plurality of track groups simultaneously; and
transmitting the multimedia file to a receiver, whereby the receiver parses the track group information corresponding to the respective track data, and decodes track data belonging to a specified track group based on the parsed track group to which the respective track data belongs.

13. A non-transitory computer-readable medium, storing a computer program, and the computer program, when executed by a processor, implementing the method of claim 1.

14. A non-transitory computer-readable medium, storing a computer program, and the computer program, when executed by a processor, implementing the method of claim 12.

15. An electronic device, comprising:
a memory, configured to store one or more programs; and
one or more processor, electrically coupled to the memory and configured to execute the one or more programs to perform the method of claim 12.

16. An electronic device, comprising:
a memory, configured to store one or more programs; and
one or more processor, electrically coupled to the memory and configured to execute the one or more programs to perform step comprising:
receiving a multimedia file, the multimedia file comprising a plurality of track data, including target track data, and track group information corresponding to the respective track data, wherein:
the track group information corresponding to the target track data comprises identification information of a plurality of track groups; and
the identification information of the plurality of track groups is used for indicating that the target track data contemporaneously belong to the plurality of track groups;
parsing the track group information corresponding to the respective track data to obtain a track group to which the respective track data belongs; and
decoding track data belonging to a specified track group based on the track group to which the respective track data belongs to obtain multimedia data corresponding to the specified track group.

17. The electronic device of claim 16, wherein the plurality of track groups comprise a first track group and a second track group, and the track group information corresponding to the target track data comprises a track group type data box corresponding to the first track group,
the track group type data box comprising identification information of the first track group and information of the second track group.

18. The electronic device of claim 17, wherein the track group type data box further comprises:
content information of the target track data under a type represented by the first track group; or
an information data box of the target track data corresponding to the first track group.

19. The electronic device of claim 17, wherein the information of the second track group comprises:
identification information of the second track group, a type of the second track group, and description information of the second track group.

20. The electronic device of claim 19, wherein the information of the second track group further comprises:
content information of the target track data under a type represented by the second track group; or
an information data box of the target track data corresponding to the second track group.
